(19) United States
(12) Patent Application Publication
(10) Pub. No.: US 2021/0162690 A1
(43) Pub. Date: Jun. 3, 2021

(54) Manufacture of Fire-Retardant Sandwich Panels

(71) Applicant: Gurit (UK) Ltd., Newport (GB)

(72) Inventors: Glynn Edwards, Newport (GB); Damian Bannister, Newport (GB)

(21) Appl. No.: 16/772,943

(22) PCT Filed: Mar. 8, 2019
(86) PCT No.: PCT/EP2019/055891

§ 371 Date: Jun. 15, 2020

(30) Foreign Application Priority Data
Mar. 9, 2018 (GB) 1803835.6

(51) Int. Cl. B29C 70/68; B29C 70/44; B29C 70/34; B29D 24/00; B32B 3/12; B32B 5/26; B32B 37/10; B32B 37/14

(52) U.S. Cl. CPC B29C 70/683; B29C 70/44; B29C 70/342; B29C 70/682; B29K 2105/0026; B32B 3/12; B32B 5/26; B32B 37/1018; B32B 37/146; B29D 24/005

(57) ABSTRACT

Fibre-reinforced composite materials, which can exhibit good fire-retardant properties in combination with good surface properties and aesthetic properties, as well as good mechanical properties, and in conjunction with good processability, with regard to cost and health and safety considerations.

### FIELD OF THE INVENTION

The present invention relates to a method for manufacturing fire-retardant sandwich panels comprising fibre-reinforced resin matrix composite materials.

### BACKGROUND

It is well known to use fibre-reinforced resin composite materials for the manufacture of structural and decorative components in a variety of industrial sectors. For some applications, the fibre-reinforced resin composite materials are manufactured from what are known in the art as prepregs—a prepreg comprises fibrous material pre-impregnated with a resin, and the amount of resin is matched to the amount of fibre so that after plural prepregs have been laid up into a mould and the resin has cured, optionally with a preliminary full wetting out of the fibrous material by the resin if the prepreg was initially not fully impregnated, a unitary fibre-reinforced composite material moulding is formed with the correct ratio of fibre to resin so that the material has the required material properties.

When a composite material is used for interior panel construction for mass transport applications, such as aerospace, trains, ferries, etc., in particular for the interiors of such vehicles, a fire, smoke and toxicity requirement is necessary. Historically, composite materials such as phenolic, cyanate-ester, sheet moulding compound (SMC), modified vinyl-ester and halogenated epoxides have been used for these applications.

Prepregs employing a phenolic-based resin have been historically used for interior panels in aerospace and mass transit applications for many decades. Typically, the interior panels for passenger aircraft are currently made from a sandwich structure using fibre-reinforced phenolic resin skins on a honeycomb core. The core thickness typically varies from 3.2 mm to 12.7 mm (⅛″ to ½″). The skin is typically a single ply of woven glass fabric impregnated with a phenolic resin matrix system, although more than one ply of woven glass fabric impregnated with a phenolic resin matrix system may be employed. The honeycomb core is typically composed of aramid fiber paper coated with a phenolic resin, for example Nomex® honeycomb available in commerce from Du Pont, USA.

Although such phenolic resins offer excellent fire, smoke and toxicity (“FST”) properties, there is an industry desire to seek replacement resin materials for such prepregs which offer improved surface properties for the resultant sandwich panels, as well as improved health and safety performance, and lower-cost processing, than phenolic resins, without compromising the FST properties provided by the known phenolic resin panels.

Phenolic resins for use in such prepregs are cured using a condensation reaction which releases volatiles and water during curing. The release of volatiles creates poor surface finishes that require significant filling and fairing of the cured components at a substantial additional cost. The release of volatile components, and solvents, also results in the need to take specific health and safety precautions when using such phenolic resins. Therefore, in addition to the additional cost of filling and fairing, the phenolic matrix in currently available phenolic resin prepregs also has a poor health and safety rating due to free formaldehyde and residual phenol.

WO-A-95/29807 discloses the manufacture of sandwich panels using phenolic resin prepregs using vacuum bag processing in which a vacuum bag assembly is transported into an oven in which air is heated by electrical heating elements and volatile gases are removed from the vacuum bag by a vacuum line.

Many phenolic resin aerospace component manufacturers have problems with the final surface quality of the phenolic resin component when removing from the mould and have to spend time filling and fairing to enable the required surface quality for painting or applying protective films, for example composed of polyvinyl fluoride, for example Tedlar® polyvinyl fluoride films available in commerce from Du Pont, USA.

A first primary surface quality defect of phenolic resin sandwich panels is the presence of porosity in the cured phenolic resin layer, particularly at a surface intended to be a cosmetic “A” surface which is mounted or intended to be viewed in use, for example an interior surface of an aircraft wall lining panel. The porosity is generally related to the void content in the cured phenolic resin layer, and a good surface finish is generally associated with low void content.

A second primary surface quality defect is known as “telegraphing”. Phenolic resin prepregs are used to form outer surface layers of sandwich panels incorporating a central core layer. Telegraphing is exhibited in a sandwich panel incorporating a cured phenolic resin layer moulded onto a core layer comprising a non-metallic honeycomb material, for example a honeycomb material composed of aramid fiber paper coated with a phenolic resin, for example Nomex® honeycomb available in commerce from Du Pont, USA. Telegraphing is a defect caused by the surface ply of the cured phenolic resin layer being slightly depressed into each cell of the honeycomb creating a dimpled texture, similar in visual appearance to the texture of a golf ball. This kind of defect is more prevalent when the component is manufactured under vacuum bag curing conditions, where the moulding pressure is provided by applying a vacuum and therefore by atmospheric pressure alone, than under press-moulding which does not typically use a vacuum.

These types of sandwich panels for interior panel constructions for transport applications, such as for aerospace interiors, are typically made by three common processes. In one known process, which is typically used for components having a complex shape, the sandwich components are laid up in an open mould and then subjected to a vacuum bag moulding process with the resin being cured in an oven or an autoclave. In a second known process, the sandwich components are compression moulded in a press; the process is known in the art as the “crushed core” process because some parts of the panel are crushed to a lower thickness than other parts. In a third known process, the sandwich components are compression moulded to form flat panels in a Multiple Opening Press (MOP) process.

As aircraft production numbers increase, it is also desirable that the resin matrix in the prepreg cures quickly to enable faster production cycle times to manufacture sandwich panels. In addition, there is a desire to reduce tooling costs and to increase production capacity on the more expensive capital equipment items, for example presses, autoclaves and ovens.

The mechanical properties of the phenolic resins are generally much lower than that of an epoxy resin but in general the mechanical requirements for aircraft interior components are low. However, it should be expected that in the future that may be an increased requirement for aircraft interior panels to have increased mechanical properties as compared to current panels. Therefore it would be desirable to produce a sandwich panel in which the surface composite material layers have increased mechanical properties as compared to current known phenolic resin sandwich panels.

US-A-2015/190973 discloses the manufacture of aircraft interior panels using a prepreg comprising an inorganic thermoset resin, for example an aluminium silicate derivative inorganic thermoset resin combined with an aluminium phosphate natural hardener and a metakaolin anti-shrinkage additive, and fire resistant natural fibres, for example flax, hemp, sisal or jute, using vacuum bag processing or a hot press.

Catalytically-cured epoxide resins are well known in the composites industry to offer excellent mechanical properties and good health and safety properties. They are however, intrinsically flammable materials and, when used unmodified, are not suitable for applications where fire, smoke and toxicity properties are required. This has mitigated against their use in the aerospace industry, particularly for interior components. Epoxides have commonly been modified with halogens (such as bromine and chlorine) in order to impart fire-retardant properties to the cured matrix. The two main disadvantages to this approach are high toxicity of smoke during combustion and poor health and safety characteristics associated with the material in both the uncured and cured state.

Therefore despite the problems with phenolic resins as described above, and in light of the disadvantages of epoxy resins as also described above, phenolic resins have been very hard to displace from these aerospace applications, particularly for interior components, due to their excellent smoke, flame resistance and heat release properties. Furthermore, phenolic resins have a low cost compared to other chemicals that have the required FST properties.

### SUMMARY OF THE INVENTION

The present inventors have addressed these problems of known sandwich panels and composite materials and have aimed to provide fire-retardant fibre-reinforced sandwich panels, comprising fibre-reinforced composite materials, which can exhibit good fire-retardant properties in combination with good surface properties and aesthetic properties, as well as good mechanical properties, and in conjunction with good processability, with regard to cost and health and safety considerations.

The present invention aims to provide a sandwich panel made from a fibre-reinforced composite material, which can provide the combination of the following properties: the heat release, smoke and flammability properties of the composite material on combustion should be close to those of current commercial phenolic resins; an improved surface finish, including low porosity and low telegraphing, as compared to current commercial phenolic resins should be achieved to reduce/eliminate fill and fairing; a fast curing resin system should be present; a similar price to that of current commercial phenolic resin sandwich panels should be available; and good mechanical performance properties for adhesion of surface layers of fibre-reinforced resin matrix composite material to a core material, such as a honeycomb core material, should be provided. Also, the sandwich panel made from the composite material should provide improved health and safety characteristics as compared to the current use of uncured and cured phenolic resins.

Accordingly, in a first aspect, the present invention provides a method of manufacturing a fire-retardant sandwich panel, the method comprising the steps of:

i. providing a mould having a moulding surface configured for moulding an outer surface of a sandwich panel;
ii. disposing onto the moulding surface a sandwich panel pre-assembly comprising a first prepreg layer having a lower surface contacting the moulding surface and an upper surface, a core layer above the first prepreg layer and contacting the upper surface, the core material comprising a structural honeycomb material, the honeycomb material having an array of cells extending through the thickness of the core layer, the cells terminating at opposite surfaces of the core layer;

wherein the first prepreg layer comprises from 44 to 52 wt % of an epoxide resin matrix system and from 48 to 56 wt % fibrous reinforcement, each wt % being based on the total weight of the prepreg layer, the fibrous reinforcement being at least partially impregnated by the epoxide resin matrix system,

iii. wherein the epoxide resin matrix system comprises the components:
a. a mixture of (i) at least one epoxide-containing resin and (ii) at least one curing agent for curing the at least one epoxide-containing resin; and
b. a plurality of solid fillers for providing fire retardant properties to the fibre-reinforced composite material formed after curing of the at least one epoxide-containing resin;
iv. sealing a sealing layer over the sandwich panel pre-assembly to provide a moulding chamber, containing the sandwich panel pre-assembly, between the moulding surface and the sealing layer;
v. applying a vacuum to the moulding chamber so that the air pressure within the moulding chamber is within the range of from −0.90 bar to −0.70 bar; and
vi. heating the sandwich panel pre-assembly within the moulding chamber to a curing temperature of the at least one epoxide-containing resin by the at least one curing agent, thereby to cure the epoxide resin matrix system and to form a fire-retardant sandwich panel comprising the core layer adjacent to, and bonded to, a first outer surface layer of fibre-reinforced resin matrix composite material formed from the first prepreg layer.

In some preferred embodiments of the present invention, in step iv the vacuum is applied to the moulding chamber so that the air pressure within the moulding chamber is within the range of from −0.85 bar to −0.75 bar.

Preferably, in the fire-retardant sandwich panel the surface which has been formed by moulding the lower surface of the first prepreg against the moulding surface has a surface porosity of up to 0.8%, more preferably up to 0.5%, yet more preferably up to 0.25%.

Preferably, in the fire-retardant sandwich panel the surface which has been formed by moulding the lower surface of the first prepreg against the moulding surface has a telegraphing value of lower than 0.5, optionally lower than 0.3, further optionally lower than 0.2.

In a second aspect, the present invention provides a fire-retardant sandwich panel made by the method of the present invention.

Preferred features of these aspects of the present invention are defined in the respective dependent claims.

The preferred embodiments of the present invention can provide a sandwich panel with epoxy resin surface layers bonded to a core layer that meets the primary requirement of the heat release and FST requirements which has been the major hurdle to be overcome by epoxy resin products for these aerospace applications in order to be competitive to, or exceed the performance of, current commercial phenolic resins. The epoxy resin surface layers can also produce a high quality cosmetic surface, for example for use as an “A” surface of a panel, which is in use mounted or intended to be seen, for example as an interior surface of an aircraft cabin.

An advantage of an epoxide resin as a monomer molecule for producing a cured thermoset resin is that the epoxide resin is cured in a catalytic addition reaction rather than a condensation reaction and so, unlike phenolic resins, the epoxide resin does not evolve any by-product during the curing reaction. Therefore when the epoxy resin used in the preferred embodiments of the present invention is cured no volatiles are evolved that might cause surface porosity.

Epoxy resins also exhibit excellent adhesive properties and mechanical properties. Therefore the epoxy resins used in the preferred embodiments of the present invention can easily meet the adhesive bonding requirements to enable the epoxy resin surface layers to bond strongly to the surface of a honeycomb core material, for example composed on Nomex® honeycomb.

The chemistry of epoxy resins also enables fast cure times over a selectable range of curing temperatures, depending upon the selection of the curing agent, and optionally the accelerator, making epoxy resins used in the preferred embodiments of the present invention suitable for the moulded panel production process of vacuum bag processing as described above.

The epoxy resin surface layers have been produced using prepregs which comprise epoxy resin in combination with the fibrous reinforcement, typically in the form of a fabric. The FST properties of epoxy resins used in the preferred embodiments of the present invention have been achieved by adding various solid fire retardant components to the epoxy formulation, in particular solid fillers, typically in particulate form, and as a result the liquid content of the prepreg, the liquid being present during curing of the prepreg at an elevated curing temperature, is relatively low as compared to epoxy prepregs which do not exhibit FST properties.

The present invention is at least partly predicated on the finding by the present inventors that when using the moulded panel production process of vacuum bag processing as described above to produce a sandwich panel, the vacuum level applied during the vacuum bag processing can affect the achievement of both low porosity and low telegraphing in the surface finish of the sandwich panel.

In particular, it has been surprisingly found that, when using the epoxy resin prepregs, exhibiting FST properties, for the surface layers, a particular range for the applied vacuum level achieves the combination of both low porosity and low telegraphing. At a reduced vacuum level (i.e. at a lower net pressure applied by the atmosphere during the vacuum bag processing) as compared to the particular range for the applied vacuum level, the porosity increases. In addition, at a higher vacuum level (i.e. at a higher net pressure applied by the atmosphere during the vacuum bag processing) as compared to the particular range for the applied vacuum level, both the porosity and telegraphing increase.

Furthermore, the present invention is also at least partly predicated on the finding by the present inventors that in a prepreg to form the surface layer of the sandwich panel there is a preferred minimum liquid resin content, the liquid resin content being the content of liquid resin during curing, that provides a combination of both (i) good adhesion strength to the honeycomb core and (ii) a good surface finish in the sandwich panel, for example so that the mould-facing side of a vacuum bag processed moulded panel can be used as a cosmetic “A” surface, for example as an interior cosmetic “A” surface of an aircraft cabin.

### BRIEF DESCRIPTION OF THE DRAWINGS

Preferred embodiments of the present invention will now be described by way of example only with reference to the accompanying drawings, in which: —

FIG. 1 is a schematic side view of a sandwich panel pre-assembly incorporating a prepreg and a core in accordance with an embodiment of the present invention;

FIG. 2 is a schematic perspective view of a sandwich panel in accordance with an embodiment of the present invention produced from the sandwich panel pre-assembly of FIG. 1;

FIG. 3 is a schematic perspective view of the sandwich panel pre-assembly of FIG. 1 during vacuum bag moulding in accordance with an embodiment of the present invention to produce the sandwich panel of FIG. 2; and

FIG. 4 is a graph showing the relationship between both (i) the surface porosity on the bottom face of a sandwich panel and (ii) the telegraphing on the bottom face of a sandwich panel with vacuum level during vacuum bag moulding as illustrated in FIG. 3 accordance with Examples of the present invention and Comparative Examples.

### DETAILED DESCRIPTION

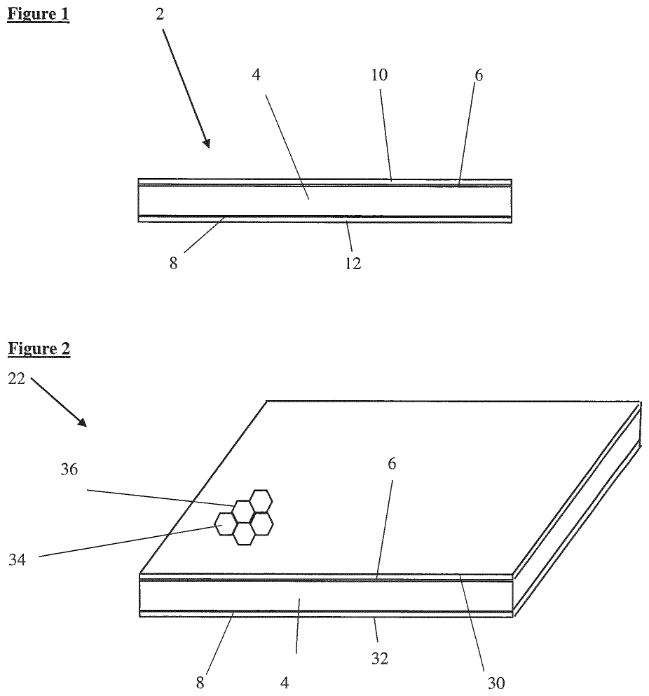

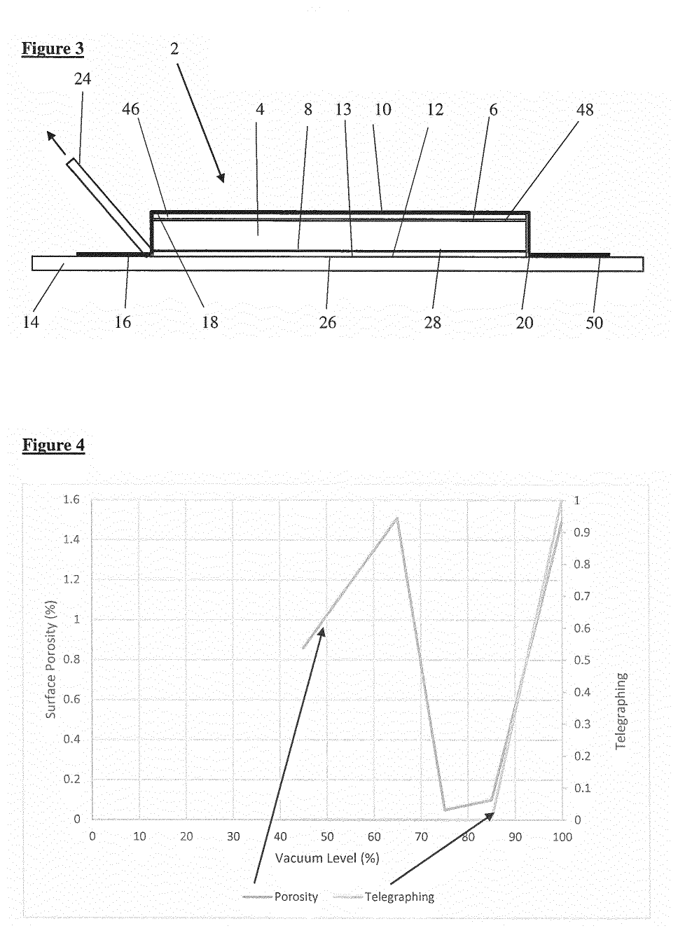

Referring to FIG. 1, there is shown a sandwich panel pre-assembly incorporating a prepreg and a core in accordance with an embodiment of the present invention prepreg. The prepreg is formulated for the manufacture of a fibre-reinforced composite material having fire retardant properties. The sandwich panel pre-assembly is used to produce a sandwich panel as shown in FIG. 2 using the method of FIG. 3. FIGS. 1, 2 and 3 are not to scale and some dimensions are exaggerated for the sake of clarity of illustration.

As shown in FIG. 1, the sandwich panel pre-assembly 2 comprises a central core layer 4 having opposite surfaces 6, 8. A prepreg layer 10, 12 is disposed on each respective surface 6, 8 of the core layer 4.

The sandwich panel pre-assembly 2 is used to produce a fire retardant sandwich panel 22 as shown in FIG. 2. The sandwich panel pre-assembly 22 comprises the central core layer 4 having opposite surfaces 6, 8. An outer layer 30, 32 of fibre-reinforced resin matrix composite material, each formed from a respective prepreg layer 10, 12, is bonded to a respective surface 6, 8 of the core layer 4. Typically, the fire-retardant sandwich panel 22 is moulded to comprise an interior panel of a vehicle, optionally an aircraft or a railway vehicle. The bonding together of the outer layers 30, 32 of fibre-reinforced resin matrix composite material to the core layer 4 is achieved during the moulding process for forming the sandwich panel 22 and the epoxy resin system in the prepreg layers 10, 12 bonds directly to the surfaces 6, 8 of the core layer 4.

In the sandwich panel 22 of the illustrated embodiment, two opposite outer layers 30, 32 of fibre-reinforced resin matrix composite material, are provided, each outer layer 30, 32 being bonded to a respective opposite surface 6, 8 of the core layer 4.

The core layer 4 is composed of a structural core material comprising a non-metallic honeycomb material. Typically, the honeycomb material is composed of aramid fiber paper coated with a phenolic resin, for example Nomex® honeycomb available in commerce from Du Pont, USA. The honeycomb material comprises an array of elongate cells 34 which extend through the thickness of the core layer 4 so that, as shown in FIG. 2, the cells 34 terminate at opposite surfaces of the core layer and each opposite surface 6, 8 of the core layer 4 is an end surface of the honeycomb material including a matrix surface 36 surrounding a plurality of cells 34. The matrix surface 36 and cells 34 are shown notionally uncovered in FIG. 2 for the sake of clarity of illustration, but they are covered by the outer layers 30, 32 of fibre-reinforced resin matrix composite material, although if the outer layers 30, 32 are translucent then the matrix surface 36 and cells 34 can be seen through the outer layers 30, 32). The core layer 4 typically has a thickness of from 3 to 25 mm, although other core thicknesses may be employed.

In alternative embodiments, the core layer 4 may be a honeycomb core material composed of aluminium or an aluminium alloy, or another honeycomb core material with the required FST performance. For example, the honeycomb core material may comprise a thermoplastic honeycomb core material, in which the thermoplastic, for example polycarbonate, has been modified or incorporates additives or a coating to impart FST properties to the core material, in particular FST properties required for transportation applications such as for use in aircraft cabins. Such a thermoplastic honeycomb core material is currently sold under the trade mark ThermHex by EconCore N.V., Belgium as further described at http://www.econcore.com/en/technology/thermhex.

The prepreg of the prepreg layers 10, 12 comprises an epoxide resin matrix system and fibrous reinforcement which is at least partially impregnated by the epoxide resin matrix system. Preferably, the prepreg is halogen-free and/or phenolic resin-free.

In the illustrated embodiment, each prepreg layer 10, 12 comprises a single prepreg ply, i.e. a single layer of fibrous reinforcement at least partially impregnated by the epoxide resin matrix system. However, in alternative embodiments, at least one of, or each, prepreg layer 10, 12 comprises a stack of two prepreg plies, the prepreg plies comprising the same epoxide resin matrix system and fibrous reinforcement, at the same weight ratios, as described herein for the prepreg layers 10, 12.

In preferred embodiments of the present invention, the prepreg of the prepreg layer 10, 12, or each ply when a stack of plies is present one or each prepreg layer 10, 12, has a total weight of from 500 to 650 g/m² and/or the fibrous reinforcement has a weight of from 250 to 350 g/m², optionally from 275 to 325 g/m².

The fibrous reinforcement may comprise one or more materials such as glass fibre, aramid fibre, carbon fibre, or PAN or pitch based carbon fibre. The fibrous reinforcement may comprise a woven or non-woven fabric.

The epoxide resin matrix system comprises the components:

a. a mixture of (i) at least one epoxide-containing resin and (ii) at least one curing agent for curing the at least one epoxide-containing resin; and
b. a plurality of solid fillers for providing fire retardant properties to the fibre-reinforced composite material formed after curing of the at least one epoxide-containing resin.

In preferred embodiments of the present invention, in component (a) the at least one epoxide-containing resin comprises a mixture of at least two epoxide-containing resins and has a liquid/solid weight ratio of from 1.3:1 to 1.475:1, typically from 1.35:1 to 1.45:1, for example from 1.38:1 to 1.39:1, the liquid and solid constituents being liquid or solid at room temperature (20° C.). In component (b), the at least one curing agent may be a liquid curing agent, or alternatively the at least one curing agent may comprise from 40 to 60 wt % solid and from 60 to 40 wt % liquid, each wt % being based on the weight of the curing agent and determined at room temperature (20° C.).

In preferred embodiments of the present invention, the at least one epoxide-containing resin, and optionally the at least one curing agent, comprise a liquid-forming component of the prepreg, which liquid-forming component is adapted to liquefy during at a curing temperature during curing of the at least one epoxide-containing resin by the at least one curing agent, and wherein the liquid-forming component of the prepreg has a weight of from 140 to 205 g/m². Typically, the liquid-forming component of the prepreg has a weight of from 150 to 180 g/m², typically from 155 to 170 g/m².

The epoxide-containing resin may further comprise a curing agent carrier which acts to assist incorporation of the latent curing agent for the epoxide resin into the composition. Typically, the carrier comprises a diglycidyl ether of bisphenol F liquid resin. For example, the carrier may comprise a diglycidyl ether of bisphenol F liquid resin available in commerce under the trade name Epikote 862 from Hexion. The carrier may typically be present in the resin composition in an amount of up to 10 wt %, based on the total weight of the epoxide-containing resin.

The at least one curing agent of component (a)(ii) comprises a curing agent, suitable for curing epoxide resins, optionally together with at least one additional curing agent additive or modifier. Any suitable curing agent may be used. The curing agent will be selected to correspond to the resin used. The curing agent may be accelerated. The curing agent may typically be selected from a dicyandiamide, sulphanilamide, urone, urea, imidazole, amine, halogenated boron complex, anhydride, lewis base, phenolic novolac, or a nitrogen containing compound. Latent curing agents such as dicyandiamide, Fenuron and imidazole may be cured. Suitable accelerators include Diuron, Monuron, Fenuron, Chlortoluron, his-urea of toluenedlisocyanate and other substituted homologues. Typically, the curing agent for the epoxide-containing resin is dicyandiamide, most preferably being in micronized form, and such a curing agent is available in commerce under the trade names Dyhard 100SF from AlzChem Group AG. The curing agent may typically be present in the resin composition in an amount of from 1 to 15 wt %, more typically from 2 to 6 wt %, based on the total weight of the epoxide-containing resin. Too low an amount of the curing agent may cause a reduced cure of the resin material, whereas too high an amount may cause an excessively exothermic cure.

The curing agent may be combined with an additional curing additive or accelerator to reduce the activation energy, and hence the curing temperature, of the primary curing agent such as dicyandiamide. Such an additive may comprise urone, available in commerce under the trade names Amicure UR-S or Amicure UR-2T from Evonik. Such an additive may typically be present in the resin composition in an amount of up to 15 wt %, more typically from 1 to 4 wt %, based on the total weight of the epoxide-containing resin.

The curing agent may be yet further be combined with an additional additive imidazole-based curing agent provided to further reduce the activation energy, and hence the curing temperature, of the urone. In addition, the C═N bonds present in imidazole have been shown to improve the fire-retardant properties of the resultant cured epoxide-resin compared to other curing agents. Such an imidazole-based curing agent is available in commerce under the trade name 2MZ-Azine-S from Shikoku, Japan. The imidazole-based curing agent may typically be present in the resin composition in an amount of up to 15 wt %, more typically from 1 to 4 wt %, based on the total weight of the epoxide-containing resin. A low amount of the imidazole-based curing agent may cause a reduced cure speed and/or reduced curing temperature of the resin material, whereas too high an amount may cause an excessively exothermic cure.

The component (b) comprises a plurality of solid fillers for providing fire retardant properties to the fibre-reinforced composite material formed after curing of the at least one epoxide-containing resin. The solid fillers promote fire-retardancy and/or reduce generation of smoke, opacity of smoke or toxicity of smoke. Such fillers may be selected from, for example, at least one of zinc borate, melamine cyanurate, red or yellow phosphorus, aluminium trihydroxide (alumina trihydrate), and/or ammonium polyphosphate. The solid fillers may include glass beads or silica beads which are non-flammable. The solid fillers are typically dispersed homogeneously throughout the epoxide resin matrix.

Some known fire retardants are, for example, the fire retardants supplied by Albemarle Corporation under the trade mark Martinal, and under the product names OL-111/LE, OL-107/LE and OL-104/LE, and the fire retardant supplied by Borax Europe Limited under the trade mark Firebrake ZB. The fire retardant mineral filler is typically ammonium polyphosphate, for example available under the trade name Exolit AP 422 from Clariant, Leeds, UK. The smoke suppressant mineral filler is typically zinc borate, available in commerce under the trade name Firebrake ZB. The mineral fillers may optionally be provided together with a filler dispersion additive to aid wetting and dispersion of fillers during manufacture of the matrix resin. Such a filler dispersion additive is available in commerce under the trade name BYK W980 from BYK Chemie, Wesel, Germany.

Typically, the solid fillers for providing fire retardant properties comprise (i) a phosphate component and (ii) (a) a ceramic or glass material precursor for reacting with the phosphate component to form a ceramic or glass material and/or (b) a ceramic or glass material. The solid fillers are present in the form of solid filler particles. The phosphate component may comprise a metal polyphosphate, optionally aluminium polyphosphate, and/or ammonium polyphosphate. The ceramic or glass material precursor may comprise a metal borate, optionally zinc borate. The ceramic or glass material may comprise glass beads.

The prepreg may further comprise, in component (b), a blowing agent as a fire retardant for generating a non-combustible gas when the prepreg is exposed to a fire, and the fire retardant solid fillers and blowing agent are adapted to form an intumescent char when the epoxide resin is exposed to a fire. The blowing agent is part of the solid fillers in the epoxide resin matrix system. A suitable blowing agent is melamine, which is present in the form of solid filler particles.

Other solid filler materials may be provided in component (b) to provide the required fire, smoke and toxicity (FST) properties to the resultant fibre-reinforced resin matrix composite material formed from the prepreg after curing of the epoxide resin matrix system.

In preferred embodiments of the present invention, the epoxide resin matrix system further comprises, in component (b), at least one anti-settling agent for the solid fillers. The anti-settling agent is typically a solid particulate material. The at least one anti-settling agent may comprise silicon dioxide, optionally amorphous silicon dioxide, further optionally fumed silica. The at least one anti-settling agent may be present in an amount of from 0.5 to 1.5 wt % based on the weight of component (a). In particular, an anti-settling additive may be provided to control resin flow during resin curing, for example during curing to adhere the resin matrix to a core. In addition, such an additive can prevent settling of powder particles, such as the fire-retardant and/or smoke suppressant fillers, in the resin formulation during storage/processing. A typical anti-settling additive comprises amorphous silicon dioxide, most typically fumed silica, for example available under the trade name Cabot Cabosil TS-720.

The prepreg comprises from 44 to 52 wt % of the epoxide resin matrix system and from 48 to 56 wt % of the fibrous reinforcement, each wt % being based on the total weight of the prepreg. Optionally, the prepreg comprises from 46 to 50 wt % of the epoxide resin matrix system and from 50 to 54 wt % of the fibrous reinforcement, each wt % being based on the total weight of the prepreg.

In addition, in preferred embodiments of the present invention, the weight ratio of component (a), i.e. the epoxide-containing resin and curing agent system, to component (b), i.e. the solid fillers for providing fire retardant properties, is from 1.4:1 to 1.86:1, preferably from 1.5:1 to 1.86:1, more preferably from 1.6:1 to 1.7:1, typically from 1.625:1 to 1.675:1, for example about 1.65:1.

In preferred embodiments of the present invention, the weight ratio of the total weight of the prepreg to the weight of component (b) is from 4.5:1 to 6.5:1, optionally from 5:1 to 6:1.

In the method of making a fire-retardant sandwich panel according to the present invention, the core layer 4 is provided. Each of two prepreg layers 10, 12 as described above is disposed onto a surface 6, 8 of the core layer 4 to form the sandwich panel pre-assembly 2.

Typically, for example when the resultant sandwich panel is for use as an interior panel in a vehicle such as an aircraft and is not required to have high mechanical properties and structural strength, a single ply of the prepreg layer 10, 12 is disposed over a respective surface 6, 8 of the core layer 4. However, in alternative embodiments the resultant sandwich panel may be required to have high mechanical properties and structural strength, and a plurality of plies of the prepreg layer 10, 12 is disposed over a respective surface 6, 8 of the core layer 4.

As described above, the present invention uses, as the moulding process for forming the panel, the known processes of vacuum bag processing, as described above.

Referring to FIG. 3, in one embodiment of a method of manufacturing a fire-retardant sandwich panel, there is provided a mould 14 having a moulding surface 16 configured for moulding an outer surface 26 of the sandwich panel 22. In the method the sandwich panel pre-assembly 2, as described above, is disposed onto the moulding surface 16. Preferably, the moulding surface is covered by a low energy coating, such as a PTFE coating. The PTFE coating is typically a mould surface reconditioning tape composed of a PTFE coated fibreglass layer, which is adhered to the mould surface by a pressure-sensitive adhesive. The PTFE coating typically has a thickness of from 125 μm (0.005 inch) to 175 μm (0.007 inch). A suitable PTFE coating is available under the product name ToolTec® A007 from Airtech Europe Sarl, Luxembourg.

In some embodiments, the lower mould 14 may be a caul plate, which is a smooth metal plate, free of surface defects, the same size and shape as a composite lay-up, used immediately in contact with the lay-up diming the curing process, which transmits normal pressure and temperature, and provides a smooth surface on the finished laminate (caul plates are disclosed at https://netcomposites.com/guide-tools/guide/repair/repair-tooling/).

In the illustrated embodiment, the sandwich panel pre-assembly 2 comprises the first prepreg layer 12 having lower surface 13 contacting, directly or indirectly, the moulding surface 16 and an upper surface 28. The core layer 4 is adjacent to the first prepreg layer 12 and contacts, directly or indirectly, the upper surface 28. In the illustrated embodiment, the sandwich panel pre-assembly 2 further comprises the second prepreg layer 10 having a lower surface 46 contacting an upper surface 48 of the core layer 4 so that the core layer 4 is sandwiched between the first and second prepreg layers 12, 10. The resultant fire-retardant sandwich panel 22 comprises the core layer 4 sandwiched between, and bonded to, first and second outer surface layers 32, 30 of fibre-reinforced resin matrix composite material respectively formed from the first and second prepreg layers 12, 10. However, in alternative embodiments, the second prepreg layer 10 is omitted.

The sandwich panel pre-assembly 2 may be pre-assembled prior to locating any component on the moulding surface 16; alternatively the sandwich panel pre-assembly 2 may be assembled, component by component, on the moulding surface 16.

Thereafter in the method, a sealing layer 18, for example a polymer sheet which is impermeable to air transport therethrough, is sealed over the sandwich panel pre-assembly 2 to provide a moulding chamber 20, containing the sandwich panel pre-assembly, between the moulding surface 16 and the sealing layer 18. As is known to those skilled in the art, the peripheral edge 50 of the sealing layer 18 is sealed to the moulding surface 16. A conduit 24 connects the moulding chamber 20 to a source of vacuum (not shown). Other features of vacuum bag processing are well-known to those skilled in the art and are not described in further detail.

A vacuum is applied to the moulding chamber 20 by extracting air from the moulding chamber 20 along the conduit 24 as shown by the arrow in FIG. 3 extending away from the conduit 24.

In some preferred embodiments of the present invention, vacuum is applied to the moulding chamber so that the air pressure within the moulding chamber is within the range of from −0.85 bar to −0.75 bar.

The applied vacuum is controlled to provide that the air pressure within the moulding chamber 20 is within the range of from −0.90 to −0.70 bar, preferably from −0.85 bar to −0.75 bar (the later values corresponding to an absolute pressure of 133 mBar and 227 mBar respectively). If all of the air was extracted from the moulding chamber 20 that would correspond to a vacuum level of 100% in the moulding chamber and if none of the air was extracted from the moulding chamber 20 that would correspond to a vacuum level of 0% in the moulding chamber; the air pressure range of from −0.90 bar to −0.70 bar corresponds to a vacuum level range of from 90 to 70% in the moulding chamber, and the air pressure range of from −0.85 bar to −0.75 bar corresponds to a vacuum level range of from 85 to 75% in the moulding chamber.

After the desired vacuum and air pressure within the moulding chamber 20 have been achieved, the sandwich panel pre-assembly 2 within the moulding chamber 20 is heated to a curing temperature of the at least one epoxide-containing resin by the at least one curing agent, thereby to cure the epoxide resin matrix system and to form the fire-retardant sandwich panel.

For example, the sandwich panel pre-assembly 2 is disposed on a lower mould and then subjected to vacuum bagging over the sandwich panel pre-assembly 2 in a process well known to those skilled in the art. The laid-up mould is placed in an oven or autoclave and the sandwich panel pre-assembly is heated to a curing temperature of the at least one epoxide-containing resin by the at least one curing agent.

In the preferred embodiments, the heating step comprises a first phase in which the sandwich panel pre-assembly 2 is heated from an initial temperature of no more than 30° C. to a dwell temperature within the range of from 50 to 100° C., optionally from 60 to 95° C. Typically, the initial temperature is within the range of from 0 to 30° C. For example, the initial temperature may range from a chill temperature, such as 3° C., to room temperature, such as 25° C. The initial temperature is typically the lay-up temperature of the sandwich panel pre-assembly 2 at which the sandwich panel pre-assembly 2 is constructed, and this varies for different resin systems and workshops. Typically, the dwell temperature is within the range of from 65 to 90° C.

In a second phase the sandwich panel pre-assembly 2 is held at the dwell temperature for a period of at least 10 minutes, for example for a period of from 10 to 45 minutes, optionally from 20 to 35 minutes.

For example, a dwell phase of 75° C. for 30 minutes, or a dwell phase of 90° C. for 10 minutes, were each found to achieve low porosity, and high climbing drum peel strength (CDP) for panels produced in accordance with the present invention.

In the preferred embodiments of the present invention, the provision of a dwell temperature of from 60 to 100° C. in the dwell phase caused the resin to have a minimum viscosity within the range of from 15 to 30 poise. For example, in the second phase the sandwich panel pre-assembly may be held at the dwell temperature within the range of from 70 to 75° C. to cause the resin to achieve a minimum viscosity within the range of from 15 to 25 poise. In a particular embodiment a dwell temperature of 75° C. in the dwell phase caused the resin to have a minimum viscosity of 20 poise.

In this specification, the minimum viscosity of the resin was measured under the following conditions. The samples were evaluated using a TA Instruments AR2000ex rheometer fitted with disposable 25 mm diameter aluminium plates and the Environmental Test Chamber. Oscillation experiments were carried out using various temperature programmes as detailed below. A controlled strain of 0.125% was used with a frequency of 1 Hz and a gap setting of 1000 μm. Data was recorded using the precision sampling mode with a minimum torque setting of 1 micro.Nm. If the torque to achieve the desired strain was below this minimum value the strain was determined by application of the minimum torque.

In a third phase the sandwich panel pre-assembly 2 is heated from the dwell temperature to a curing temperature within the range of from 100 to 150° C. Typically, in the third phase the curing temperature is within the range of from 120 to 150° C.

Finally, in a fourth phase the sandwich panel pre-assembly 2 is held at the curing temperature for a curing period to cure the epoxide resin matrix system. Typically, in the fourth the curing period is at least 30 minutes.

During the heating step, the at least one epoxide-containing resin, and optionally the at least one curing agent, in the prepreg of the layer(s) 10, 12 liquefy to form a liquid-forming component which wets the surface(s) 10, 12 of the core layer 4. Preferably, the liquid-forming component which wets the surface of the core layer 4 has a weight of from 140 to 205 g/m². Typically, the liquid-forming component has a weight of from 150 to 180 g/m², typically from 155 to 170 g/m².

The heating step cures the at least one epoxide-containing resin to form the layer(s) of fibre-reinforced composite material 30, 32 bonded to the core layer 4.

During the heating step, the prepreg layer(s) 10, 12 and core layer 4 are pressed together as a result of the net atmospheric pressure applied by the vacuum bag processing. The prepreg layer(s) 10, 12 and core layer 4 may be moulded to form a moulded sandwich panel 22 having a three dimension moulded shape.

The mould 14 forms a moulded surface of the sandwich panel. In accordance with the preferred embodiments, the lower mould 14 forms a sufficiently high quality surface finish, with the combination of low porosity and low telegraphing to enable that moulded surface to be used as a high quality cosmetic “A” surface, for example as an interior cosmetic “A” surface of an aircraft cabin.

Preferably, in the fire-retardant sandwich panel 22 the surface 26 which has been formed by moulding the lower surface 13 of the first prepreg 12 against the moulding surface 16 has a surface porosity of up to 0.8%, more preferably up to 0.5%, yet more preferably up to 0.25%.

Preferably, in the fire-retardant sandwich panel 22 the surface 26 which has been formed by moulding the lower surface 13 of the first prepreg 12 against the moulding surface 16 has a telegraphing value of lower than 0.5, optionally lower than 0.3, further optionally lower than 0.2.

The preferred embodiments of the present invention provide an epoxy resin prepreg that has very good FST properties, in particular smoke and heat release. In addition it has good mechanical properties, surface finish quality, and there is no condensation reaction in contrast to phenolic resins, and a fast cure time that provide the epoxy resin prepreg with numerous advantages over the current phenolic materials that are currently commercially used to produce aircraft interior panels, and panels for other transportation applications, such as in trains. The preferred embodiments of the present invention provide a sandwich panel which exhibits the combination of the key characteristics of a high quality surface finish coupled with high FST properties as a function of the resin content of the prepreg relative to the solid filler content provided by the fire retardant component and in particular the liquid resin content of the prepreg during curing.

The epoxide resin employed in accordance with the preferred embodiments of the present invention is a catalytically-cured non-elimination resin. Therefore no volatiles are released during cure. As compared to condensation-cured resins, such as phenolic resins, this provides the advantage of allowing components to be cured using lower-cost vacuum bag technology with significantly reduced refinishing and processing costs.

The epoxide resin employed in accordance with the preferred embodiments of the present invention is a halogen-free, modified-epoxide matrix resin and unlike phenolic systems, does not contain residual phenol or solvents. This means that it can be used in aircraft interior parts such as cosmetic cabin panels and in air-conditioning ducting without the risk of toxic phenol being leached into the passenger air supply. The halogen-free, epoxide matrix resin avoids the smoke toxicity issues associated with halogenated epoxides.

Fire-retardant fillers were added to the epoxide resin matrix employed in accordance with the preferred embodiments of the present invention to improve the smoke release and smoke toxicity properties of the matrix resin.

The present invention has particular application in the manufacture of multilaminar composite sandwich panels comprising a central core, for example of a honeycomb material itself known in the art, and two opposed outer plies comprising fibre-reinforced composite material incorporating a resin matrix produced in accordance with the present invention.

The preferred embodiments of the present invention provide a prepreg epoxide-containing resin which exhibits a combination of properties in order to achieve sufficient peel adhesion to a core such as a honeycomb core, a high surface quality, for example to provide a cosmetic “A” surface finish, and good FST properties.

Both the moulding process, by using a particular vacuum range, and the composition of the outer prepregs layer(s) are controlled to achieve the combination of low porosity and low telegraphing in the cured resin so that the surface quality of the resultant sandwich panel is high.

The epoxide-containing prepreg resin is preferably formulated to have a liquid resin content during cure which is sufficiently high to assure sufficient resin flow during cure in order to form sufficient contact area with the honeycomb cell surface to achieve good adhesion and to have a low porosity and low telegraphing in the cured resin so that the surface quality of the resultant sandwich panel is high.

The epoxide-containing prepreg resin is preferably formulated to have a liquid resin content during cure which is sufficiently low to reduce the heat and smoke release from the cured resin so that the FST properties of the resultant sandwich panel are high, and in particular comply with the minimum FST properties to qualify for use inside aircraft cabins.

In other words, a preferred range for the liquid resin content during cure provides the combination of (i) high surface quality of the resultant sandwich panel and (ii) high FST properties of the resultant sandwich panel, which comply with the minimum FST properties to qualify for use inside aircraft cabins. When coupled with a selected vacuum range for the vacuum bag moulding process, unexpected improvements in surface finish, in particular the combination of low porosity and low telegraphing, were achieved.

The modified epoxide-containing matrix resin system used in the prepregs, resultant cured composite materials, and sandwich panels of the present invention has particular application for use for interior panel construction for mass transport applications where a fire, smoke and toxicity requirement is necessary. The composite materials made using such a resin can provide significant advantages over the known resins discussed above, such as phenolic, cyanate-ester, SMC, modified vinyl-ester and halogenated epoxides which have been used in the past for these applications.

The epoxide-containing matrix resin of the preferred embodiments of the present invention may be used in structural applications where fire, smoke and toxicity performance that is similar to phenolic materials is required yet with greatly increased surface quality, and also good mechanical properties such as peel strength of the outer composite material layer to the core of a sandwich panel. Additional advantages include ease of processing and reduced refinishing which allow substantial capital and production cost reductions.

Phenolic resin panels tend to be dark brown in colour and so are commonly painted to achieve the desired component colour. The paint can also improve the surface finish. Problems can occur during service whereby if the material is scratched; the base colour of the phenolic becomes highly visible. The epoxide-containing matrix resin of the preferred embodiments of the present invention may be white in colour which reduces the visual impact of such scratching during use, and does not require painting, in particular because the surface finish is high. However, in some embodiments of the present invention the panel surface may be painted in order to provide enhanced protection from ultra-violet (UV) radiation and scratches, and to provide a cosmetic finish (i.e. colour matching, surface texture, paint effects). In the absence of any paint layer, this provides the advantage of faster part production and reduced costs to the panel producer.

The epoxide-containing matrix resin of the preferred embodiments of the present invention can provide a number of technical benefits as compared to known prepregs and composite materials having fire and/or smoke resistance. In particular, there may be provided in accordance with the present invention:
A phenol-free alternative to phenolic prepregs.
No volatiles are released during cure—improved mechanical properties.
Does not require high-pressure press tooling to process, can use low-cost vacuum-bag technology.
High-quality surface finish “straight from tooling”—does not require expensive and time-consuming refinishing.
Pale-colour—requires less surface coating to achieve desired aesthetic and results in increased longevity during operation (i.e. scratches etc. are less visible).

The epoxide material used in accordance with the present invention may be used by manufacturers of composite prepregs and sandwich panels for use in a wide-range of fire-retardant applications. The prepreg offers an alternative to a wide-range of existing fire-retardant materials including (but not limited to) phenolics, halogenated epoxides, and cyanate esters but with significant advantages of the combination of enhanced fire-retardant, smoke and toxicity (FST) properties, enhanced good surface quality, and good mechanical properties, together with good resin processing.

The preferred embodiments of the present invention will now be described further with reference to the following non-limiting Examples.

### Example 1

A prepreg was formed comprising a single ply of woven glass fibre as a fibrous reinforcement and an epoxide resin matrix system of the present invention.

The epoxide resin matrix system comprised, as a first component, the combination of (i) an epoxide-containing resin and (ii) a curing agent for curing the an epoxide-containing resin of the present invention.

The epoxide resin matrix system further comprised, as a second component, fire retardant/non-flammable solid fillers. The fire retardant fillers comprised ammonium polyphosphate, melamine powder, and glass beads.

The epoxide resin matrix system comprised 52.34 wt % epoxide-containing resin, 9.91 wt % curing agent and 37.75 wt % fire retardant/non-flammable solid fillers, based on the total weight of the epoxide resin matrix system.

The total weight of the prepreg was 555 gsm, comprised of 300 gsm woven glass fibre and 255 gsm of the epoxide resin matrix system, which included the epoxide resin, the curing agent and the solid fillers. This provided 46 wt % epoxide resin matrix system content and 54 wt % fibrous reinforcement content in the prepreg (however the fabric weight has a tolerance variation of +/−10 wt %, with consequential tolerance in the wt % of epoxide resin matrix system content in the prepreg). The prepreg was formulated so that upon curing at the elevated curing temperature of 125° C., the liquid content of the prepreg was 159 gsm.

The composition of the epoxide resin matrix system, expressed as weight per unit area (gsm), is shown in Table 1.

TABLE 1

| | Example |
|---|---|
| | 1-gsm |
| Mixture of epoxide-containing resin | 159 |
| and a curing agent | |
| Solid fillers for fire retardancy | 96 |
| Glass fibres as fibrous reinforcement | 300 |
| Total Prepreg weight | 555 |
| Liquid content of prepreg at the cure | 159 |
| temperature which comprised liquefied | |
| epoxide-containing resin and curing agent | |

Therefore the weight ratio of the first component to the second component was 1.6:1. The prepreg comprised 46 wt % of the epoxide resin matrix system and 54 wt % fibrous reinforcement, each wt % being based on the total weight of the prepreg. The weight ratio of the total weight of the prepreg to the weight of the fire retardant solid fillers was 5.78:1.

A honeycomb core material composed of aramid fiber paper coated with a phenolic resin, in particular composed of Nomex® available in commerce from Du Pont, USA, was provided. The core had a thickness of 3.2 mm A single ply of the prepreg was disposed over each opposite major surface of the core and the resultant three-layer assembly of prepreg/core/prepreg was placed in a laboratory scale vacuum bag moulding apparatus as described above configured to mould the lower surface of a panels against a mould surface.

The moulding surface was covered by a PTFE coating. The PTFE coating was a mould surface reconditioning tape composed of a PTFE coated fibreglass layer, which was adhered to the mould surface by a pressure-sensitive adhesive. The PTFE coating had a thickness of 125 μm (0.005 inch) and is available under the product name ToolTec® A007 from Airtech Europe Sarl, Luxembourg.

After vacuum bagging, the moulding chamber was evacuated to a desired vacuum pressure of −0.75 bar (corresponding to a vacuum level of 75% as described above).

Thereafter the heating and curing cycle was as follows: from an initial chill temperature of 3° C. in a first phase the sandwich panel pre-assembly was heated to a dwell temperature of 75° C. and in a second phase the sandwich panel pre-assembly was held at the dwell temperature for a period of 30 minutes. In a third phase the sandwich panel pre-assembly was heated from the dwell temperature to a curing temperature of 125° C. and in a fourth phase the sandwich panel pre-assembly was is held at the curing temperature for a curing period of 60 minutes.

The moulded panel was removed from the mould and the lower moulded surface was investigated to measure the surface porosity and the telegraphing.

The surface porosity, otherwise herein called the void content, on the bottom surface of the sandwich panel was measured. In the measuring process, a black ink was applied to the surface and then wiped using a dry cloth. This resulted in pigmentation of depressed areas (voids). Surface scans were taken of the panel surface and image analysis software was used to calculate the percentage area of ink using contrast detection methods. The surface porosity is a measure of the percentage surface area of the bottom surface of the sandwich panel which corresponded to the percentage area of ink, which in turn correlates to the surface porosity, and thereby correlates to the void content.

Preferably, in the fire-retardant sandwich panel the surface which has been formed by moulding the lower surface of the first prepreg against the moulding surface has a surface porosity of up to 0.8%, more preferably up to 0.5%, yet more preferably up to 0.25%.

The results are shown in Table 2 and FIG. 4.

The data shows that providing a vacuum pressure of −0.75 bar (corresponding to a vacuum level of 75% as described above) achieved a surface porosity of 0.05%. The measured surface porosity was significantly lower than would be achieved is using a phenolic resin in the outer layer plies of the sandwich panel using a vacuum bag processing method at any applied vacuum level. This low surface porosity is significantly below a most desired maximum threshold of 0.25% to permit the surface to be used as a high quality cosmetic “A” surface of the moulded panel.

The data also showed that providing a vacuum pressure of −0.75 bar (corresponding to a vacuum level of 75% as described above) achieved a telegraphing value lower than 0.2. The telegraphing value was quantified visually; a scalar, dimensionless range of from 0 to 1 was established, the value of 0 corresponding to a complete absence of any visible telegraphing and the value of 1 corresponding to an unacceptably high presence of visible telegraphing, which would be rejected as providing an A-surface finish, for example of an interior panel of a vehicle such as an aircraft. Preferably, in the fire-retardant sandwich panel the surface which has been formed by moulding the lower surface of the first prepreg against the moulding surface has a telegraphing value of lower than 0.5, optionally lower than 0.3, further optionally lower than 0.2.

It can be seen from Table 2 and FIG. 4 that the selected vacuum value of Example 1 achieved excellent low surface porosity and excellent low telegraphing.

The climbing drum peel strength (CDP in N/75 mm) was measured to measure the peel strength of the composite material ply on the core layer; the results are shown in Table 2.

TABLE 2

| | | | Surface | Tele- | Climbing drum |
|---|---|---|---|---|---|
| | | Dwell- | porosity | graphing | peel (CDP) |
| | Vacuum- | ° C., | on bottom | on bottom | Strength- |
| | bar (%) | min | face-% | face | N/75 mm |
| Ex. 1 | 5 | 5, 30 | 0.05 | 0 | 71 |
| Ex. 2 | 85 | 5, 30 | 0.1 | 0 | 97 |
| Ex. 3 | 75 | 5, 15 | 0.01 | 0 | 50 |
| Ex. 4 | 75 | 0, 10 | 0.1 | 0 | 102 |
| C. Ex. 1 | 100 | 5, 30 | 1.49 | 1 | 60 |
| C. Ex. 2 | 5 | 5, 30 | 1.51 | 0 | 63 |
| C. Ex. 3 | 45 | 5, 30 | 0.86 | 0 | 43 |
| C. Ex. 4 | 75 | 5, 30 | 7.95 | 0 | 64.5 |
| C. Ex. 5 | 100 | 5, 30 | 16.1 | 1 | 65 |
| C. Ex. 6 | 75 | None | 1.33 | 0 | 88 |
| C. Ex. 7 | 75 | None | 7.67 | 0 | 62 |

The composition of the resultant sandwich panel was subjected to a number of additional tests to determine the FST (in particular the fire-retardance and smoke suppression) properties of the sandwich panel.

The compositions of the vacuum moulded sandwich panels of the Examples and Comparative Examples were also used to form pressed panels which were formed by press moulding. The fire-retardance and smoke suppression properties of the pressed sandwich panels were measured, and these were considered to represent the corresponding properties of the vacuum moulded sandwich panels of the Examples and Comparative Examples because these properties are primarily dependent upon the composition of the layers of the sandwich panels. The sandwich panel was tested during combustion to measure the smoke density (Ds, a unitless parameter), after a combustion period of 4 minutes, and the peak heat release (Peak HR in kW/m²); the results are shown in Table 3.

TABLE 3

| | Liquid | | Peak |
|---|---|---|---|
| | content of | Ds | HR |
| | prepreg (gsm) | (4 min) | (kW/m²) |
| Composition of | 159 | 49.1 | 109.8 |
| Panel of Ex. 1 | | | |
| Composition of | 125 | 58.1 | 103.3 |
| Panel of C. Ex. 8 | | | |
| Composition of | 229 | 76.3 | 126.0 |
| Panel of C. Ex. 9 | | | |
| Composition of | 280 | 101.5 | 121.9 |
| Panel of C. Ex. 10 | | | |

The peak heat release was measured using a cone calorimeter that was used to evaluate the combusting sandwich panel. The Peak HR value refers to a cone calorimeter measurement which is not the same as the Ohio State University (OSU) heat release parameter specified in the Federal Aviation Regulations (FAR) of the United States of America. The cone calorimeter values are systematically higher than the OSU values, and the cone calorimeter and OSU values demonstrate a positive mutual correlation. Therefore the cone calorimeter values represent compliance with the OSU standard.

The data shows that providing a liquid content in the prepreg upon curing of 159 gsm achieved a low surface porosity on the bottom surfaces of the sandwich panel using the vacuum bag moulding process at the selected vacuum pressure range. The measured surface porosity was significantly lower than would be achieved is using a phenolic resin in the outer layer plies of the sandwich panel. This low surface porosity is below a desired maximum threshold to permit the surface to be used as a high quality cosmetic “A” surface of the moulded panel.

The data also showed that providing a liquid content in the prepreg upon curing of 159 gsm achieved a low smoke density and low peak heat release. Table 3 shows the smoke density Ds was below a desired maximum threshold of 100 and that the peak heat release, peak HR, was below a desired maximum threshold of 120 kW/m². This liquid resin content provided good fire retardant properties and good smoke suppression to the sandwich panel, which were comparable to results obtained using a phenolic resin in the outer layer plies of the sandwich panel.

It is to be noted that the maximum threshold values for some density and peak heat release vary depending on the specific application (e.g. location, assembly and modifications of the panel when used in an aircraft). The Federal Aviation Regulations (FAR) of the United States of America state a value of <200 Ds (4 minutes) for smoke density and 65 kW/m² for heat release after both 2 minutes and at peak heat release rate using OSU heat release methods. The panel of Example 1 clearly meets these criteria. However, it is important to note that panels are often post-processed with surface coverings (paints, protective films, carpeting etc), and therefore limits for laminates are often required to be significantly lower than these FAR limits, depending on the specific application.

In summary, the use of an epoxy resin system within the scope of the present invention for the outer surface ply of a sandwich panel was found to provide an improved combination of properties as compared to known phenolic resin sandwich panel. In particular, the surface finish is improved without materially compromising the FST properties. The climbing drum peel strength is also high, and comparable or higher for panels produced according to the present invention as compared to conventional phenolic resin panels. The high climbing drum peel strength exhibits improved toughness and adhesion of the single composite ply to the core and allows lighter weight structures to be engineered for applications in and outside of aerospace. While the FST properties of an epoxy resin system within the scope of the present invention may be slightly worse than comparable phenolic resin system, the FST properties are nevertheless still comfortably within the requirements for a resin (which may be phenolic) in current aerospace standards set by major aircraft manufacturers and by the Federal Aviation Regulations (FAR) of the United States of America. Moreover, surface properties, and mechanical properties, of the epoxy resin system within the scope of the present invention are improved compared to a comparable phenolic resin system. These improved properties can be achieved without requiring high pressure moulding or high temperature autoclaving.

The epoxide resin matrix system used in Example 1, having the composition as summarised in Table 1, was subjected to a heating and curing cycle as described above to determine the minimum viscosity of the resin during a heating and curing cycle used to manufacture the sandwich panel pre-assembly according to the method of the present invention. The heating and curing cycle was implemented while measuring the viscosity of the epoxide resin matrix system in a TA Instruments AR2000ex rheometer used in the testing protocol for measuring minimum viscosity as described above.

In order to replicate the heating and curing cycle of epoxide resin matrix system in Example 1, in the rheometer the epoxide resin matrix system was subjected to the following heating phases:

Phase 1—Heating from 30° C. to 100° C. at 3° C./minute—to ramp-up the temperature from room temperature to a dwell temperature;
Phase 2—Isothermal at 100° C. for 10 minutes—to maintain the temperature at the dwell temperature;
Phase 3—Heating from 100° C. to 125° C. at 3° C./minute—to ramp-up the temperature from the dwell temperature to a curing temperature;
Phase 4—Isothermal at 125° C. for 60 minutes—to maintain the temperature at the curing temperature.

The viscosity measurement for this dwell setting is shown in Table 4.

TABLE 4

| | Dwell | Dwell | Minimum |
|---|---|---|---|
| | Temp.-° C. | Time-mins | viscosity-poise |
| Example 1 | 75 | 30 | 20.2 |
| Example 3 | 85 | 15 | 20.2 |
| Example 4 | 90 | 10 | 29.3 |
| Example 5 | 60 | 45 | 15 |
| Example 6 | 65 | 45 | 19.1 |

The epoxy resin system of Example 1 achieved a minimum viscosity of about 20 poise which was associated with the optimum combination of heating and curing cycle parameters to achieve minimum surface porosity.

### Example 2

Example 1 was repeated but using a vacuum pressure of −0.85 bar (corresponding to a vacuum level of 85% as described above) which achieved a surface porosity of 0.1% and a telegraphing value of 0. It can be seen from Table 2 and FIG. 4 that the selected vacuum value of Example 2 achieved excellent low surface porosity and excellent low telegraphing.

### Comparative Example 1

Example 1 was repeated but using a vacuum pressure of −1.00 bar (corresponding to a vacuum level of 100% as described above) which achieved a high surface porosity of 1.49% and a high telegraphing value of 1. It can be seen from Table 2 and FIG. 4 that the selected vacuum value of Comparative Example 1 resulted in unacceptably poor surface porosity and unacceptably poor telegraphing.

### Comparative Example 2

Example 1 was repeated but using a vacuum pressure of −0.65 bar (corresponding to a vacuum level of 65% as described above) which achieved a high surface porosity of 1.51% and a low telegraphing value of 0. It can be seen from Table 2 and FIG. 4 that the selected vacuum value of Comparative Example 2 resulted in unacceptably poor surface porosity, although acceptable telegraphing.

### Comparative Example 3

Example 1 was repeated but using a vacuum pressure of −0.45 bar (corresponding to a vacuum level of 45% as described above) which achieved a high surface porosity of 0.86% and a low telegraphing value of 0. It can be seen from Table 2 and FIG. 4 that the selected vacuum value of Comparative Example 3 resulted in unacceptably poor surface porosity, although acceptable telegraphing.

In summary, the data of Table 2 and FIG. 4 shows that the selected vacuum range of from −0.85 bar to −0.75 bar (corresponding to a vacuum level of 85 to 75% as described above) unexpectedly resulted in the combination of very low surface porosity and very low telegraphing, enabling the moulded surface to be qualified as a high quality A-surface finish.

### Comparative Example 4

Example 1 was repeated but the weight ratio of the epoxide resin system to the fibrous reinforcement provided a resin content of 42 wt %, based on the total weight of the prepreg layer. The remaining parameters, namely the vacuum level of 75% and the heating and curing cycle with a dwell period of 30 minutes at 75° C., were maintained as in Example 1. Comparative Example 4 achieved a surface porosity of 7.95%. This suggests that an excessively low resin content during the heating and curing cycle, even when a dwell period is present, prevents the achievement of low surface porosity. This Comparative Example shows that when the first prepreg layer comprises from 44 to 52 wt % of an epoxide resin matrix system and from 48 to 56 wt % fibrous reinforcement, each wt % being based on the total weight of the prepreg layer, the first prepreg layer can achieve very low surface porosity in the resultant vacuum moulded layer, and conversely reducing the % resin content undesirably increases the surface porosity vacuum moulded layer. There was no telegraphing, which is a result of the vacuum level being 75%.

### Comparative Example 5

Example 1 was repeated but the weight ratio of the epoxide resin system to the fibrous reinforcement provided a resin content of 42 wt %, based on the total weight of the prepreg layer. In addition, the vacuum level was 100%. Comparative Example 5 achieved a surface porosity of 16.1%. This again suggests that an excessively low resin content during the heating and curing cycle, even when a dwell period is present, prevents the achievement of low surface porosity.

### Comparative Example 6

Example 1 was repeated but omitting a dwell period during the heating and curing cycle. Comparative Example 6 achieved a surface porosity of only 1.33%. This suggests that a dwell period during the heating and curing cycle assists the achievement of low surface porosity.

### Comparative Example 7

In Comparative Example 7, Comparative Example 5 was repeated, but modified by applying a 75% vacuum and also by omitting a dwell period during the heating and curing cycle. Comparative Example 7 achieved a surface porosity of only 7.67%. This again suggests that providing a low resin content and omitting a dwell period during the heating and curing cycle prevents the achievement of low surface porosity.

### Example 3

Example 1 was repeated but the dwell period during the heating and curing cycle was at a higher temperature of 85° C. Example 3 achieved a lower surface porosity of 0.01%. As shown in Table 4, the epoxy resin system of Example 3 using the heating and curing cycle of Example 3 achieved, as for Example 1, a minimum viscosity of about 20 poise which was associated with the optimum combination of heating and curing cycle parameters to achieve minimum surface porosity.

### Example 4

Example 1 was repeated but the dwell period during the heating and curing cycle was at a higher temperature of 90° C. Example 4 achieved a low surface porosity of 0.1%. As shown in Table 4, the epoxy resin system of Example 4 using the heating and curing cycle of Example 4 achieved a minimum viscosity of about 29 poise which was associated with the optimum combination of heating and curing cycle parameters to achieve minimum surface porosity.

### Examples 5 and 6

Table 4 shows that using different heating and curing cycle parameters of temperature and time can achieve similar minimum viscosity values and therefore a range of temperature and time dwell parameters can be employed to achieve the desired minimum viscosity and consequently the desired low surface porosity. The combined data of Examples 1, 5 and 6 and Comparative Example 6 shows that a dwell period at a selected temperature during the heating and curing cycle assists the achievement of low surface porosity.

The combined data of Examples 1 and 2, and Comparative Examples 1 to 7, shown in Table 2 shows that Examples 1 and 2 exhibit the lowest (i.e. best) surface porosity as these Examples 1 and 2 employed 75-85% vacuum, 46% resin content and a dwell period, at 75° C., which achieves a minimum resin viscosity during the dwell period of from 15 to 30 poise, for example preferably about 20 poise.

Example 4 shows that achieving a minimum viscosity of about 29 poise during the heating and curing cycle incorporating a dwell phase exhibited very low surface porosity. Examples 5 and 6 show that similar minimum viscosities can be achieved using lower dwell temperatures and longer dwell times.

Table 4 shows that a desired minimum resin viscosity during the dwell period is within the range of from 15 to 30 poise, for example preferably about 20 poise, to achieve the desired low surface porosity.

Comparative Examples 1-5 and 7 exhibit worse (i.e. higher) surface porosity as compared to Examples 1 and 2 because Comparative Examples 1, 2 and 3 employed lower or higher vacuum levels than Examples 1 and 2, and Comparative Examples 4 and 5 had a lower resin content than Examples 1 and 2 and also Comparative Example 7 had no dwell period.

Comparative Example 6 exhibits worse (i.e. higher) surface porosity as compared to Examples 1 and 2 due to lack of any dwell period.

Concerning the climbing drum peel strength (CDP) values, typical commercial phenolic resins used in sandwich panels for transport, e.g. aerospace, applications exhibit a CDP with a range of approximately from 70 to 90 N/75 mm Phenolic resins generally have lower toughness than epoxy resins, which is no dependent on the moulding (e.g. pressing) conditions. Thus the vacuum moulded panels of the present invention provided comparable CDP strength as compared to panels comprising typical phenolic resins.

### Comparative Example 8

Example 1 was repeated, using the same fabric, but the weight ratio of the epoxide resin system to the fibrous reinforcement provided a resin content of 40 wt %, based on the total weight of the prepreg layer, and the ratio of the first and second components of the epoxide resin matrix system was modified to provide that liquid content of the resin upon curing was decreased to 125 gsm.

The sandwich panel was tested to measure the surface porosity on the bottom surface of the sandwich panel. As described above, FST properties were tested on pressed panels, which had been press moulded rather than vacuum moulded, and the smoke density, and the peak heat release were measured on pressed panels having the same composition as the vacuum moulded panels.

It was found that providing a low liquid content in the prepreg upon curing of about 125 gsm, and a low resin content, the surface porosity on the bottom surface of the sandwich panel was unacceptably high, being above 2%. The measured surface porosity would not provide any significant improvement over the known use of a phenolic resin in the outer layer plies of the sandwich panel.

As shown in Table 3, the data also showed that providing a low liquid content in the prepreg upon curing of about 125 gsm achieved even lower smoke density and peak heat release as compared to the 159 gsm liquid content of Example 1. This is believed to result from the reduced resin content providing a lower organic material content for combustion.

In summary, Comparative Example 8 shows that a minimum liquid content in the epoxy resin prepreg upon curing is required to achieve a combination of both a good surface finish and FST properties, and good mechanical properties.

### Comparative Examples 9 and 10

Example 1 was repeated, using the same fabric, but the weight ratio of the epoxide resin system to the fibrous reinforcement provided a resin content of 55 wt % for Comparative Example 9 and 60 wt % for Comparative Example 10, based on the total weight of the prepreg layer, and the ratio of the first and second components of the epoxide resin matrix system was modified to provide that liquid content of the resin upon curing was increased to 229 gsm for Comparative Example 9 and 280 gsm for Comparative Example 10.

Again, the sandwich panel was tested to measure the surface porosity on the bottom surface of the sandwich panel, and a corresponding pressed panel was tested to measure the smoke density, and the peak heat release.

It was found that providing a high liquid content in the prepreg upon curing of about 230 gsm or about 280 gsm, can provide a low surface porosity on the bottom surface of the sandwich panel which would provide a significant improvement over the known use of a phenolic resin in the outer layer plies of the sandwich panel.

However, the results shown in Table 3 also showed that providing a high liquid content in the prepreg upon curing of above about 230 gsm resulted in high smoke density and high peak heat release, at least the peak heat release value being unacceptably high, as compared to the 159 gsm liquid content of Example 1. This is believed to result from the increased resin content providing a higher organic material content for combustion.

In summary, Example 1 and Comparative Examples 8 to 10 cumulatively show that by providing a selected range for the liquid content in the epoxy resin prepreg upon curing, the desired combination of both a good surface finish and high FST properties can be achieved in a sandwich panel having epoxy resin composite material outer plies.

### Example 7

Example 1 was repeated using a different prepreg layer. The prepreg layer comprised the same resin system and woven glass fibre as used in Example 1. However, the prepreg comprised 44 wt % of the epoxide resin matrix system and 56 wt % of the 300 gsm woven glass fibre. The Nomex® core had a thickness of 12.7 mm. The vacuum was 75%, i.e. −0.75 bar, and the cure cycle had a dwell of 30 minutes at 75° C. (i.e. as for Example 1). The cure cycle differed from Example 1 in that the isothermal fourth phase at 125° C. was for a period of 30 minutes (rather than 60 minutes in Example 1).

The void content of the resultant panel was determined and the results are shown in Table 5. Table 5 shows that the surface porosity on the moulded bottom face (i.e. the average void content) was 0.01%.

### Example 8

Example 7 was repeated, but in this Example each prepreg layer comprised a stack of two prepreg plies, each prepreg ply comprising the same prepreg as the single prepreg layer of Example 7.

The void content of the resultant panel was determined and the results are shown in Table 5 which shows that the surface porosity on the moulded bottom face (i.e. the average void content) was 0.00%.

Examples 7 and 8 cumulatively show that by increasing the number of prepreg plies, and in particular thereby providing an additional prepreg ply remote from the mould surface, and therefore which additional prepreg ply does not define the moulded surface of the panel, the void content is reduced even further. This technical result is unexpected, and provides a further preferred aspect of the invention to reduce void content at the surface of a moulded sandwich panel.

TABLE 5

| | | Surface porosity |
|---|---|---|
| | Prepreg structure | on bottom face-% |
| Example 7 | 1 ply, 44 wt % resin | 0.01 |
| Example 8 | 2 plies, 44 wt % resin | 0.00 |
| Comp. Ex. 11 | 1 ply, 42 wt % resin | 9.83 |
| Comp. Ex. 12 | 2 plies, 42 wt % resin | 1.76 |

### Comparative Examples 11 and 12

Examples 7 and 8 were repeated using a different prepreg layer. Comparative Examples 11 and 12 respectively correspond to Examples 7 and 8, the only change being the composition of the prepreg layer(s).

The prepreg layer comprised the same resin system and woven glass fibre as used in Examples 7 and 8. However, the prepreg comprised 42 wt % of the epoxide resin matrix system and 58 wt % of the 300 gsm woven glass fibre.

The surface porosity on the moulded bottom face (i.e. the average void content) of the resultant panels was determined and the results are shown in Table 5 which shows that in Comparative Example 11 the average void content was 9.83% and in Comparative Example 12 the average void content was 1.76%. These values are significantly higher than the results for Examples 7 and 8.

Comparative Examples 11 and 12 show that decreasing the resin content of the prepreg below the recited threshold of 44 wt % unacceptably increases the average void content even when a stack of two prepreg plies is used. Although the stack of two prepreg plies tends in general to decrease the void content, if the resin content is below 44 wt % the use of a prepreg stack still cannot attain an acceptable void content.

The cumulative data of Examples 7 and 8 and Comparative Examples 11 and 12 therefore reinforces the technical significance of the minimum resin content of 44 wt % in the prepreg, irrespective of the number of prepreg plies in each prepreg layer, for achieving low surface void content in sandwich panels moulded using vacuum bag processing.

In summary therefore, in accordance with the present invention it has been found that the first prepreg layer, and the second prepreg layer when present on an opposite side of the core, to form the desired moulded surface of the sandwich panel, is, or are, required to comprise a minimum content of the epoxide resin matrix system and a maximum content of the fibrous reinforcement to achieve low surface porosity—if the content of the epoxide resin matrix system is too low, the porosity becomes unacceptably high.

Conversely, the first prepreg layer, and second prepreg layer if present, are required to comprise a maximum content of the epoxide resin matrix system and a minimum content of the fibrous reinforcement to achieve good FST properties, such as low smoke density and low peak heat release—if the content of the epoxide resin matrix system is too high, the smoke density and low peak heat release become unacceptably high.

Accordingly, in accordance with the present invention the first prepreg layer, and second prepreg layer if present, are required to comprise from 44 to 52 wt % of the epoxide resin matrix system and from 48 to 56 wt % fibrous reinforcement, each wt % being based on the total weight of the prepreg layer. Preferably, in addition the epoxide resin matrix system is formulated so that during the heating and curing cycle the at least one epoxide-containing resin, and optionally the at least one curing agent, liquefy to form a liquid-forming component which wets the surface of the core layer prior to curing and solidification of the epoxide resin matrix system, and the liquid-forming component has a weight of from 140 to 205 g/m².

By providing this preferred range of the liquid-forming component, the combination of both (i) a good surface finish and (ii) high FST properties can be achieved in a sandwich panel having epoxy resin composite material outer plies.

Various modifications to the preferred embodiments of the present invention will be apparent to those skilled in the art.

1. A method of manufacturing a fire-retardant sandwich panel, the method comprising the steps of:
i. providing a mould having a moulding surface configured for moulding an outer surface of a sandwich panel;
ii. disposing onto the moulding surface a sandwich panel pre-assembly comprising a first prepreg layer having a lower surface contacting the moulding surface and an upper surface, a core layer above the first prepreg layer and contacting the upper surface, the core material comprising a structural honeycomb material, the honeycomb material having an array of cells extending through the thickness of the core layer, the cells terminating at opposite surfaces of the core layer;
wherein the first prepreg layer comprises from 44 to 52 wt % of an epoxide resin matrix system and from 48 to 56 wt % fibrous reinforcement, each wt % being based on the total weight of the prepreg layer, the fibrous reinforcement being at least partially impregnated by the epoxide resin matrix system,
wherein the epoxide resin matrix system comprises the components:
a. a mixture of (i) at least one epoxide-containing resin and (ii) at least one curing agent for curing the at least one epoxide-containing resin; and
b. a plurality of solid fillers for providing fire retardant properties to the fibre-reinforced composite material formed after curing of the at least one epoxide-containing resin;
iii. sealing a sealing layer over the sandwich panel pre-assembly to provide a moulding chamber, containing the sandwich panel pre-assembly, between the moulding surface and the sealing layer;
iv. applying a vacuum to the moulding chamber so that the air pressure within the moulding chamber is within the range of from −0.90 bar to −0.70 bar; and
v. heating the sandwich panel pre-assembly within the moulding chamber to a curing temperature of the at least one epoxide-containing resin by the at least one curing agent, thereby to cure the epoxide resin matrix system and to form a fire-retardant sandwich panel comprising the core layer adjacent to, and bonded to, a first outer surface layer of fibre-reinforced resin matrix composite material formed from the first prepreg layer.

2. A method according to claim 1 wherein the sandwich panel pre-assembly further comprises a second prepreg layer having a lower surface contacting an upper surface of the core layer so that the core layer is sandwiched between the first and second prepreg layers, wherein the second prepreg layer also comprises from 44 to 52 wt % of the epoxide resin matrix system and from 48 to 56 wt % fibrous reinforcement, each wt % being based on the total weight of the second prepreg layer, the fibrous reinforcement being at least partially impregnated by the epoxide resin matrix system, and the fire-retardant sandwich panel comprises the core layer sandwiched between, and bonded to, first and second outer surface layers of fibre-reinforced resin matrix composite material respectively formed from the first and second prepreg layers.

3. A method according to claim 1 wherein the, at least one of, or each prepreg layer comprises a stack of two prepreg plies, each prepreg ply comprising from 44 to 52 wt % of the epoxide resin matrix system and from 48 to 56 wt % fibrous reinforcement, each wt % being based on the total weight of the prepreg ply, the fibrous reinforcement being at least partially impregnated by the epoxide resin matrix system.

4. A method according to claim 1 wherein the or each prepreg layer comprises from 46 to 50 wt % of the epoxide resin matrix system and from 50 to 54 wt % fibrous reinforcement, each wt % being based on the total weight of the prepreg layer.

5. A method according to claim 1 wherein the or each prepreg layer, or the or each prepreg ply, has a total weight of from 500 to 650 g/m² and the fibrous reinforcement has a weight of from 250 to 350 g/m² or from 275 to 325 g/m².

6. (canceled)

7. (canceled)

8. A method according to claim 1 wherein the heating step comprises (a) a first phase in which the sandwich panel pre-assembly is heated from an initial temperature of no more than 30° C. to a dwell temperature within the range of from 50 to 100° C., (b) a second phase in which the sandwich panel pre-assembly is held at the dwell temperature for a period of at least 10 minutes, (c) a third phase in which the sandwich panel pre-assembly is heated from the dwell temperature to a curing temperature within the range of from 100 to 150° C., and (d) a fourth phase in which the sandwich panel pre-assembly is held at the curing temperature for a curing period to cure the epoxide resin matrix system.

9. A method according to claim 8 wherein the initial temperature is within the range of from 0 to 30° C.

10. A method according to claim 8 wherein the dwell temperature is within the range of from 60 to 100° C. or 60 to 95° C. or 65 to 90° C.

11. A method according to claim 8 wherein in the second phase the sandwich panel pre-assembly is held at the dwell temperature for a period of from 10 to 45 minutes, or 20 to 35 minutes.

12. A method according to claim 8 wherein in the second phase the sandwich panel pre-assembly is held at the dwell temperature to cause the resin to achieve a minimum viscosity within the range of from 15 to 30 poise and wherein in the second phase the dwell temperature is within the range of from 60 to 100° C.

13. (canceled)

14. A method according to claim 12 wherein in the second phase the sandwich panel pre-assembly is held at the dwell temperature to cause the resin to achieve a minimum viscosity within the range of from 15 to 25 poise and wherein in the second phase the dwell temperature is within the range of from 70 to 75° C.

15. (canceled)

16. A method according to claim 8 wherein in the third phase the curing temperature is within the range of from 120 to 150° C.

17. A method according to claim 8 wherein in the fourth the curing period is at least 30 minutes.

18. A method according to claim 1 wherein the core layer is composed of a honeycomb material which is a non-metallic honeycomb material composed of aramid fiber paper coated with a phenolic resin or a metallic honeycomb material composed of aluminum or an aluminum alloy.

19. (canceled)

20. (canceled)

21. A method according to claim 1 wherein the weight ratio of component a to component b is from 1.4:1 to 1.86:1, from 1.5:1 to 1.86:1, from 1.6:1 to 1.7:1, from 1.625:1 to 1.675:1 or about 1.65:1.

22. (canceled)

23. (canceled)

24. (canceled)

25. (canceled)

26. A method according to claim 1 wherein the weight ratio of the total weight of the prepreg layer to the weight of component b is from 4.5:1 to 6.5:1 or from 5:1 to 6:1.

27. (canceled)

28. A method according to claim 1 wherein in step v the at least one epoxide-containing resin, or the combination of the at least one epoxide-containing resin and the at least one curing agent, liquefy to form a liquid-forming component which wets the surface of the core layer prior to curing and solidification of the epoxide resin matrix system, wherein in the or each prepreg layer the liquid-forming component has a weight of from 140 to 205 g/m², from 150 to 180 g/m², or from 155 to 170 g/m².

29. (canceled)

30. (canceled)

31. (canceled)

32. A method according to claim 1 wherein the or each prepreg layer is halogen-free and/or phenolic resin-free.

33. A method according to claim 1 wherein the or each prepreg layer further comprises, in component b, a blowing agent as a fire retardant for generating a non-combustible gas when the prepreg, or fibre-reinforced composite material made therefrom, is exposed to a fire, and the fire retardant solid fillers and blowing agent are adapted to form an intumescent char when the epoxide resin is exposed to a fire.

34. A method according to claim 1 wherein the solid fillers for providing fire retardant properties comprise (i) a phosphate component and (ii) (a) a ceramic or glass material precursor for reacting with the phosphate component to form a ceramic or glass material and/or (b) a ceramic or glass material.

35. A method according to claim 34 wherein the phosphate component comprises a metal or ammonium polyphosphate, and/or the ceramic or glass material precursor comprises a metal borate, optionally zinc borate, and/or the ceramic or glass material comprises glass beads.

36. A method according to claim 1 wherein the epoxide resin matrix system further comprises, in component b, at least one anti-settling agent for the solid fillers, wherein the anti-settling agent is a solid particulate material and comprises silicon dioxide, amorphous silicon dioxide, or fumed silica, and wherein the at least one anti-settling agent is present in an amount of from 0.5 to 1.5 wt % based on the weight of component a.

37. (canceled)

38. (canceled)

39. A method according to claim 1 wherein in step iv the vacuum is applied to the moulding chamber so that the air pressure within the moulding chamber is within the range of from −0.85 bar to −0.75 bar.

40. A method according claim 1 wherein in the fire-retardant sandwich panel the surface which has been formed by moulding the lower surface of the first prepreg against the moulding surface has a surface porosity of up to 0.8%, up to 0.5%, or up to 0.25%.

41. A method according to claim 1 wherein in the fire-retardant sandwich panel the surface which has been formed by moulding the lower surface of the first prepreg against the moulding surface has a telegraphing value of lower than 0.5, or lower than 0.3, or optionally lower than 0.2.

42. A method according to claim 1 wherein the mould is composed of a glass fibre-reinforced resin matrix composite material and the moulding surface is coated with a coating layer comprising a PTFE resin.

43. (canceled)

44. A method according to claim 1 wherein the fire-retardant sandwich panel comprises an interior panel of a vehicle, or an aircraft or a railway vehicle.

45. (canceled)
